(19) United States
(12) Patent Application Publication
(10) Pub. No.: US 2002/0005769 A1
(43) Pub. Date: Jan. 17, 2002

(54) FILTER ELEMENT AND FABRICATION THEREOF

(76) Inventors: TAKAYUKI HIRABAYASHI, TOKYO (JP); AKIHIKO OKUBORA, KANAGAWA (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/374,111

(22) Filed: Aug. 16, 1999

(30) Foreign Application Priority Data
Aug. 24, 1998 (JP) 10-237130

(51) Int. Cl. H01P 1/203; H01P 3/08

(52) U.S. Cl. 333/204; 333/246; 333/238

(57) ABSTRACT

The present invention is to realize a filter element comprising an element consisting of a strip line having an approximately uniform line width which is effective to improve the production yield and reliability. Cavities are provided on the surface of a dielectric substrate, a strip conductive pattern is formed partially on the cavities to serve as inductance.

### BACKGROUND OF THE INVENTION

1. Field of the Invention

The present invention relates to a filter element, and more particularly relates to a distributed constant filter.

1. Description of Related Art

In the field of high frequency application technology which uses microwave band or milliwave band as carrier such as cellular telephone and radio LAN, the filter elements such as low pass filter (LPF) and band pass filter (BPF) are usually designed not based on concentrated constant in which chip parts such as inductance and capacitor are used but based on distributed constant with microstrip line.

FIG. 8 is a plan view for illustrating the structure of a conventional filter element, and this is an example in which a microstrip line LPF in which the impedance is varied alternately is formed in the form of a pattern on a dielectric substrate such as a ceramic substrate. In FIG. 8, 1 denotes a dielectric substrate such as a printed substrate or ceramic substrate, 2 denotes a strip conductor pattern, and 3 denotes an I/O electrode line.

Further in FIG. 8, the (a) part which has a width of about 0.1 mm and a length of about 0.3 mm functions as an inductance, and the (b) part which has a width of about 5mm and a length of about 3 mm functions as a capacitor. By optimizing such pattern, the signal having a band higher than a desired frequency can be attenuated.

An equivalent circuit which is equivalent to this circuit is shown in FIG. 9. A filter having the flat structure of this type can be formed simultaneously in a process for forming a wiring pattern on a mounting substrate by printing or lithography.

The distributed constant filter element as described herein above is involved in the problem as described herein under.

The inductance effect of the equivalent circuit shown in FIG. 9 is reduced due to the effect of the parasitic capacitance of the dielectric between the substrate and the pattern in the frequency range of microwave and milliwave, particularly in the frequency range exceeding 5 GHz. To prevent such reduction and to obtain the desired filter performance, it is required to increase the inductance by thinning the (a) part in FIG. 8. Further, to reduce the passband loss, it is required to shorten the length of thin (a) part as short as possible. When such requirement is satisfied, further the resultant circuit pattern is involved in the problem as described herein under.

1) The (a) part may require μm order accuracy, and it is therefore difficult to obtain high production yield.

2) The (a) part having a short length results in strong electromagnetic coupling unnecessarily between (b) parts each other, and it is difficult to obtain desired filter performance.

3) The difference in line width between the (a) part and (b) part is too large, and in some cases, the line width of the (b) part is 10 times that of the (a) part. The large difference causes a large stress at the contact between the (a) part and (b) part during temperature cycling, and the large stress may cause disconnection. The disconnection results in poor reliability.

4) If a device which generates heat during operation such as a power amplifier is mounted on a substrate on which the filter has been formed, the heat may burn the thin pattern of the (a) to cause disconnection.

As described herein above, a filter element which uses a conventional microstrip line is disadvantageous in that the production yield is low because of the difference in size particularly in line width of the parts, one of which is a component for functioning as inductance and the other of which is a component for functioning as capacitance, the stress is caused locally during temperature cycle, and the disconnection is caused often.

The present invention was accomplished to solve the above-mentioned problem, and it is the object of the present invention to realize a filter element comprising an element consisting of a strip line with an approximately uniform line width which is effective to improve the production yield and reliability by applying a relatively simple method, and it is the other object of the present invention to provide a fabrication method for fabricating the above-mentioned element easily at high production yield.

### SUMMARY OF THE INVENTION

To achieve the above-mentioned objects, the present invention provides a filter element fabricated by forming a strip conductive circuit pattern on a dielectric substrate, wherein the filter element is provided with cavity spaces having an aperture respectively on the surface of the dielectric substrate, and the strip conductive circuit pattern is formed partially on the cavity spaces.

The present invention provides a filter element fabricated by forming a strip conductive circuit pattern on a dielectric substrate, wherein the width of the strip conductive circuit pattern is maintained constant and the relative dielectric constant of the dielectric substrate is differentiated partially.

The present invention provides a method for fabricating a filter element fabricated by forming a strip conductive circuit pattern on a dielectric substrate, wherein the method for fabricating a filter element comprises an opening step for forming cavity spaces with opening on the surface of the dielectric substrate, a filling step for filling filler in the cavity spaces so as to flatten the surface, a pattern forming step for forming the strip conductive circuit pattern on the dielectric substrate including the surface on the filler filled in the cavity spaces, and a removing step for removing the filler from the cavity spaces.

### BRIEF DESCRIPTION OF THE DRAWINGS

FIG. 1 is a plan view for illustrating the structure of a filter element in accordance with one embodiment of the present invention.

FIG. 2 is a cross sectional view of the filter element in accordance with the embodiment shown in FIG. 1.

FIG. 3 is a simulation diagram of impedance of the inductance portion of the embodiment shown in FIG. 1 and the conventional example.

FIG. 4 is a plan view for illustrating the structure of a filter element in accordance with another embodiment of the present invention.

FIG. 5 is a plan view for illustrating the structure of a filter element in accordance with yet another embodiment of the present invention.

FIG. 6A to FIG. 6E are diagrams for describing a fabrication process of a filter element of the present invention.

FIG. 7 is a plan view for illustrating a circuit structure in accordance with another embodiment of the present invention.

FIG. 8 is a plan view for illustrating a conventional filter element.

FIG. 9 is an equivalent circuit of the filter element shown in FIG. 8.

### DETAILED DESCRIPTION OF THE PREFERRED EMBODIMENTS

Embodiments of the filter element in accordance with the present invention will be described in detail hereinafter with reference to the attached drawings.

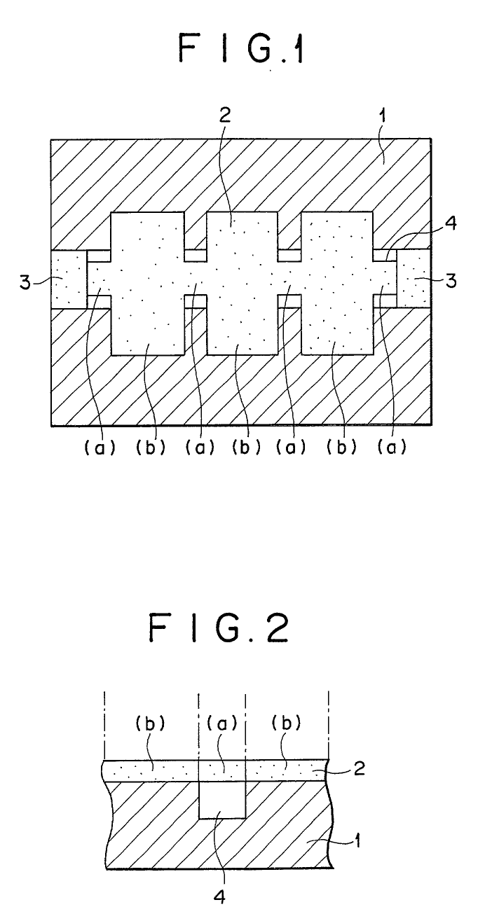

First the basic concept of the present invention is described herein under. FIG. 1 is a plan view for illustrating the structure of a filter element in accordance with one embodiment of the present invention, and FIG. 2 is a cross sectional view of the filter element.

In the present invention as shown in FIG. 1 and FIG. 2, the (a) part shown in FIG. 8 is formed on a cavity of a substrate and on the other hand the (b) part shown in FIG. 8 is formed on the substrate so that these components form a continuous pattern as in the case shown in FIG. 8. In FIG. 1 and FIG. 2, 1 denotes a dielectric substrate such as a printed substrate or a ceramic substrate, 2 denotes a strip conductive pattern consisting of Ni/Au plated Cu print pattern, 3 denotes an I/O electrode line, 4 denotes a cavity, (a) is a part for functioning as inductance, and (b) is a part for functioning as capacitance.

Because the (a) part is not formed on the dielectric substrate but formed on the spatial space as described herein above, the (a) part is effective as inductance though the (a) part is formed thin not excessively and a desired filter is obtained without increased loss though the pattern is formed short not excessively.

The pattern size required to obtain the same inductance effect in the case that the (a) part is formed on the space according to the present invention and in the case that the (a) part is formed on a substrate according to the conventional method is compared.

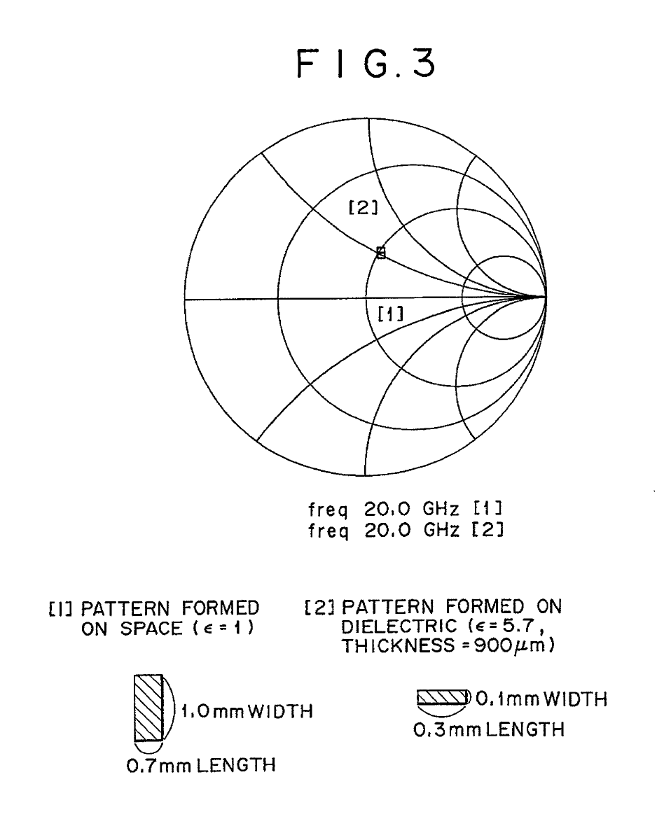

FIG. 3 is a diagram obtained by simulating the input impedance (S11) at the 50 Ω terminal in the (a) part shown in FIG. 1 and the (a) part shown in FIG. 8. Herein, the relative dielectric constant of the space is 1.0, the relative dielectric constant of the dielectric is 5.7, and the thickness of the dielectric is 900 μm.

The pattern size for giving the approximately same inductive behavior of the both corresponds to [1] for the (a) part shown in FIG. 1, namely the width of 1.0 mm and the length of 0.7 mm, and corresponds to [2] for the (a) part shown in FIG. 8, namely the width of 0.1 mm and the length of 0.3 mm. [1] is 10 times larger than [2] in the width and double larger in the length, and thereby the above-mentioned problem is significantly mitigated.

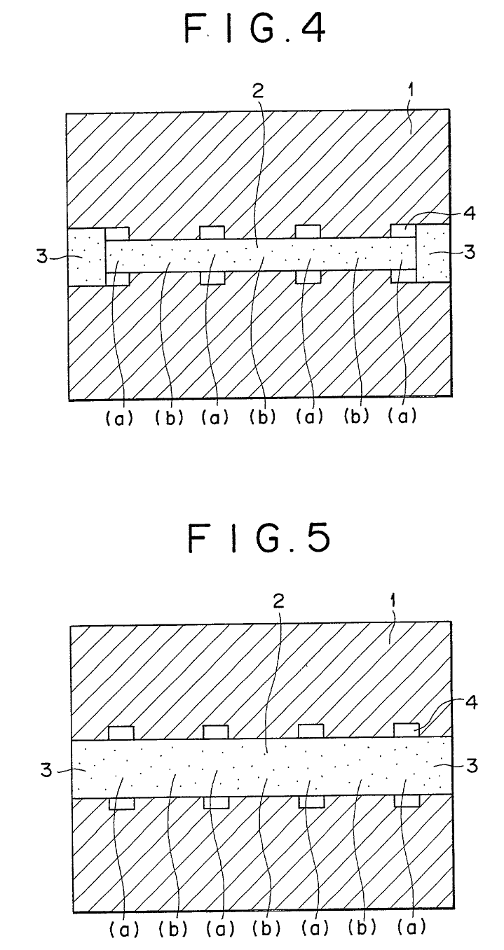

By employing a material used for forming the portion of the substrate where the (b) part is formed shown in FIG. 1 and FIG. 2 having a relative dielectric constant of, for example, 50, the line width of the (b) part can be made narrow. Therefore, by combining the above-mentioned methods, namely forming of the (a) part on the space and using of a material having high relative dielectric constant, it is possible to obtain a desired filter having the (a) part and (b) part having the quite same pattern width as shown in FIG. 4. The pattern width of the (a) part is not different from that of the (b) part.

Further, it is possible to quite equalize the width of the I/O electrode wiring 3 to that of the filter part by optimizing the relative dielectric constant and the pattern size as shown in FIG. 5.

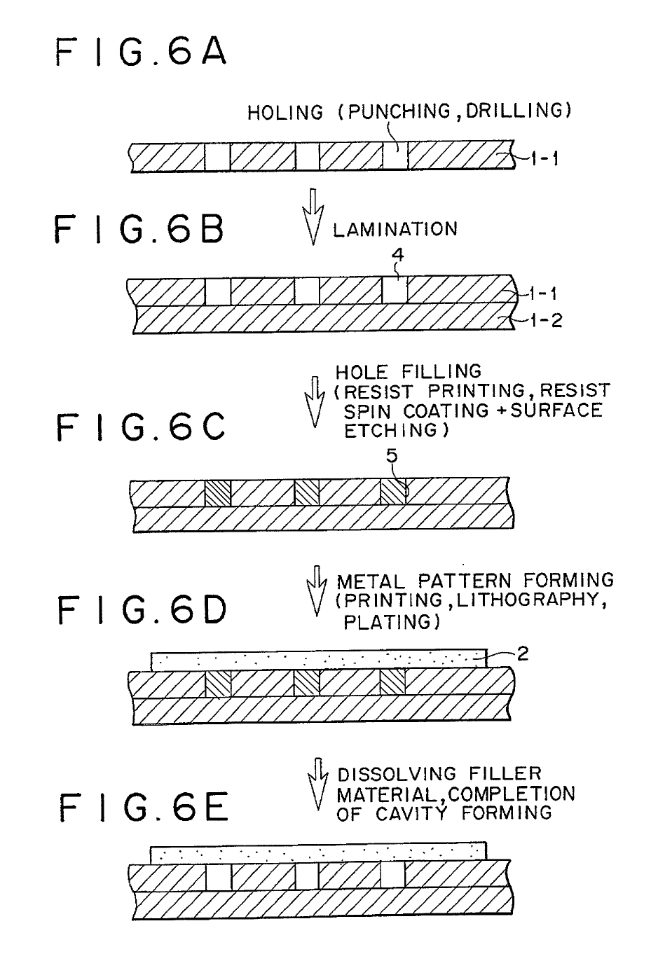

The structure of the filter element described herein above is fabricated by use of a process, for example, as described herein under in FIG. 6. In FIG. 6A to FIG. 6E, 1-1 denotes a dielectric substrate 1 consisting of epoxy material, fluoro-material, or ceramic material, 1-2 denotes a dielectric substrate 2 consisting of epoxy material, fluoro-material, or ceramic material, 2 denotes a metal pattern consisting of Cu print on which Ni/Au is plated, 4 denotes a hole, and 5 denotes a hole filling material such as photoresist.

a) First, the dielectric layer 1 (epoxy material, fluoro-material, or ceramic material) is punched or drilled to form holes 4 to be served as cavities of the present invention.

b) Next, the dielectric 1 is laminated on another dielectric 2.

c) Holes 4 of the dielectric 1 is filled with photoresist 5 by printing so that the surface level of hollow portions is equalized to the surface level of the non-hollow portion. The method for filling is by no means limited to printing, otherwise for example, a method in which the entire surface is spin coated and then etched back by dry etching may be employed.

d) After the holes 4 are filled, a filter pattern 2 consisting of metal is formed by printing or plating.

e) After the pattern 2 is formed, the photoresist 5 filled in the holes 4 is solved out with organic solvent such as acetone. Otherwise, the photoresist 5 may be solved out by oxygen plasma ashing. As the result, the structure shown in FIG. 1 and FIG. 2 is obtained.

In the above-mentioned description, though the cavity where inductance is formed is spatial space, the same effect is obtained by filling the cavity with a material having a low relative dielectric constant.

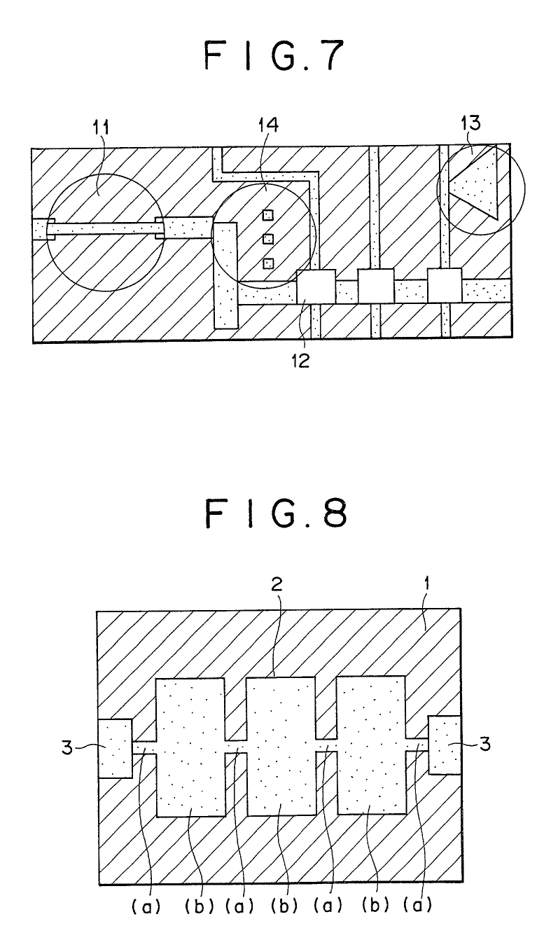

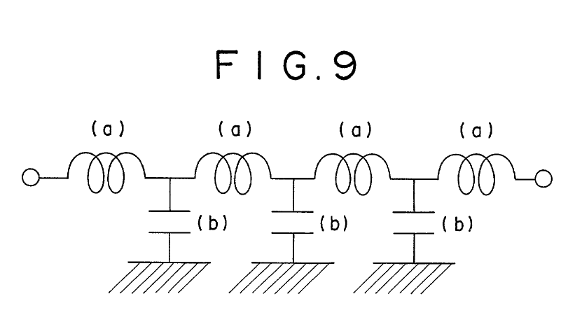

In spite of the filter single structure as described herein above, the present invention can be applied to a substrate having a filter on which active elements such as IC are mounted as shown in FIG. 7. In FIG. 7, 11 denotes a filter, 12 denotes an active element, 13 denotes a high frequency removing pattern, and 14 denotes an impedance matching pattern.

According to the present invention described hereinbefore, the present invention is advantageous in that;

1) the risk of disconnection can be reduced by equalizing the line width,

2) the occurrence of unnecessary electromagnetic coupling due to excessive mutual approach of patterns is reduced,

3) the deterioration of production yield due to variation of the line width is reduced because somewhat thick line width can be applied though the line width is inevitably made thin conventionally,

4) the risk of burn disconnection of the filter pattern is reduced even though a power amplifier or the like is mounted on the same substrate and significant heat generation causes temperature rise,

5) the line width of filter input/output can be equalized to the line width of wiring pattern (usually 50 Ω width) by optimizing the pattern width and pattern length, and

6) the structure can be formed by somewhat modifying the conventional fabrication process.

As described hereinbefore, the invention described in claim 1 of the present invention provides a filter element fabricated by forming a strip conductive circuit pattern on a dielectric substrate, wherein the filter element is provided with cavity spaces having an aperture respectively on the surface of the dielectric substrate, and the strip conductive circuit pattern is formed partially on the cavity spaces.

As the result, the relative dielectric constant of the part where the cavity spaces are formed is reduced, the strip line width of the portion where inductance is formed can be approximately equalized to that of the portion where capacitance is formed, and thus the production yield and reliability of the filter element is improved.

According to claim 2 of the present invention, the cavity spaces are filled with material having a relative dielectric constant different from that of the dielectric substrate.

As the result, the strip line on the cavity spaces is reinforced, and the reliability of the filter element is further improved.

The invention described in claim 3 of the present invention provides a filter element fabricated by forming a strip conductive circuit pattern on a dielectric substrate, wherein the width of the strip conductive circuit pattern is maintained constant and the relative dielectric constant of the dielectric substrate is differentiated partially.

As the result, the strip line is formed easily, and the production yield and reliability of the filter element is improved.

The invention described in claim 4 of the present invention provides a method for fabricating a filter element fabricated by forming a strip conductive circuit pattern on a dielectric substrate, wherein the method for fabricating a filter element comprises an opening step for forming cavity spaces with opening on the surface of the dielectric substrate, a filling step for filling filler in the cavity spaces so as to flatten the surface, a pattern forming step for forming the strip conductive circuit pattern on the dielectric substrate including the surface on the filler filled in the cavity spaces, and a removing step for removing the filler from the cavity spaces.

As the result, the strip line width of the portion where inductance is formed can be approximately equalized to that of the portion where capacitance is formed, and thus the production yield and reliability of the filter element is improved.

According to the invention described in claim 5 of the present invention, the filler is polymer material, and the filler is solved out and removed by use of organic solvent which is dissolvable of the polymer material in the removing step.

As the result, the cavity spaces are formed more easily, the filter element having a uniform strip line width is fabricated easily at high production yield.

What is claimed is:

1. A filter element fabricated by forming a strip conductive circuit pattern on a dielectric substrate,
said filter element being provided with cavity spaces having an aperture respectively on the surface of said dielectric substrate, and
said strip conductive circuit pattern being formed partially on the cavity spaces.

2. A filter element as claimed in claim 1, wherein said cavity spaces are filled with material having a relative dielectric constant different from that of said dielectric substrate.

3. A filter element fabricated by forming a strip conductive circuit pattern on a dielectric substrate, wherein the width of said strip conductive circuit pattern is maintained constant and the relative dielectric constant of said dielectric substrate is differentiated partially.

4. A method for fabricating a filter element fabricated by forming a strip conductive circuit pattern on a dielectric substrate, wherein said method for fabricating a filter element comprises:
an opening step for forming cavity spaces with opening on the surface of said dielectric substrate;
a filling step for filling filler in said cavity spaces so as to flatten the surface;
a pattern forming step for forming said strip conductive circuit pattern on said dielectric substrate including the surface on said filler filled in said cavity spaces; and
a removing step for removing said filler from said cavity spaces.

5. A method for fabricating a filter element as claimed in claim 4, wherein said filler is polymer material, and said filler is removed by solving out said filler by use of organic solvent which dissolves said polymer material in said removing step.
